(19) United States
(12) Patent Application Publication
(10) Pub. No.: US 2026/0147647 A1
(43) Pub. Date: May 28, 2026

(54) SYSTEMS AND METHODS FOR DECENTRALIZING AGENTIC APPLICATIONS

(71) Applicant: Cisco Technology, Inc., San Jose, CA (US)

(72) Inventors: Hendrikus G. P. Bosch, Amstelveen (NL); Jeffrey M. Napper, Delft (NL); Alessandro Duminuco, Milano (IT); Alex Jauch, San Carlos, CA (US); Andre Jean Marie Surcouf, Saint Leu La Foret (FR); Guillaume Sauvage De Saint Marc, Sevres (FR); Jodee A. Varney, Portland, OR (US); Frank Brockners, Köln (DE)

(21) Appl. No.: 19/256,980

(22) Filed: Jul. 1, 2025

Related U.S. Application Data
(60) Provisional application No. 63/725,065, filed on Nov. 26, 2024.

(51) Int. Cl. G06F 9/54; G06F 8/30

(52) U.S. Cl. CPC G06F 9/546; G06F 8/311

(57) ABSTRACT

In an embodiment, a method includes sharing, via a publication-subscription (pub-sub) bus, an unaddressed message between a plurality of agents. The unaddressed message includes a program counter pointing to a first instruction of a program written in a programming language. The method also includes determining, by each respective agent of the plurality of agents, whether the respective agent can perform the instruction and, in response to a first agent of the plurality of agents determining that the first agent can perform the instruction, consuming, by the first agent, the unaddressed message. The method further includes removing, by the first agent, the unaddressed message from the bus, performing, by the first agent, the instruction, adding, by the first agent, one to the program counter, and posting, by the first agent, a response to the pub-sub bus for further processing of the program.

### RELATED APPLICATIONS

This application claims priority to U.S. Provisional Patent Application No. 63/725,065, filed Nov. 26, 2024, which is hereby incorporated by reference in its entirety.

### TECHNICAL FIELD

The present disclosure relates generally to distributed application solutions, and more particularly, to systems and methods for decentralizing agentic applications.

### BACKGROUND

Agentic artificial intelligence (AI) is a term used to describe AI agents that can solve complex goals (semi-) autonomously. When deployed, a set of AI agents work together to generate solutions to a stated problem, and then collectively and by consensus generate an acceptable outcome to the task at hand. AI agents can be pre-canned, self-trained, generated while using existing (foundational) models or by way of tooling, and/or specifically fine-tuned for use cases and extended similar to regular programs. Examples for AI applications include automating software development, automating application operations and cloud security processes, implementing and maintaining cloud application operations, managing financial operations, handling customer management campaigns, organizing travel and healthcare, and so on. AI assistants may be considered simple AI agents as compared to full-blown AI agents that take their own decisions with the consent of humans but without any human supervision.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates a system for decentralizing agentic applications, in accordance with certain embodiments.

FIG. 2 illustrates a method for decentralizing agentic applications, in accordance with certain embodiments.

FIG. 3 illustrates a computer system, in accordance with certain embodiments.

### DESCRIPTION OF EXAMPLE EMBODIMENTS

### Overview

According to an embodiment, a method includes sharing, via a publication-subscription (pub-sub) bus, an unaddressed message between a plurality of agents. The unaddressed message includes a program counter pointing to a first instruction of a program written in a programming language. The method also includes determining, by each respective agent of the plurality of agents, whether the respective agent can perform the instruction and, in response to a first agent of the plurality of agents determining that the first agent can perform the instruction, consuming, by the first agent, the unaddressed message. The method further includes removing, by the first agent, the unaddressed message from the bus, performing, by the first agent, the instruction, adding, by the first agent, one to the program counter, and posting, by the first agent, a response to the pub-sub bus for further processing of the program.

In certain embodiments, the method includes determining, by a second agent of the plurality of agents, that the program ended and/or deleting, by the second agent and in response to determining that the program ended, the unaddressed message from the pub-sub bus.

In some embodiments, the method includes capturing, by a second agent of the plurality of agents, the unaddressed message in response to the unaddressed message encountering an error.

In certain embodiments, the method includes replicating, by a second agent of the plurality of agents, the unaddressed message to create a replicated unaddressed message, posting, by the second agent, the replicated unaddressed message to the pub-sub bus, consuming, by a third agent of the plurality of agents, the replicated unaddressed message, and/or performing, by the second agent, an instruction of the program in parallel with the first agent.

In some embodiments, the method includes replacing the first agent by removing the first agent from the pub-sub bus and installing a new agent on the pub-sub bus.

In certain embodiments, the plurality of agents includes one or more agents that implement control functions in the programming language. In some embodiments, the method includes tracking, by an execution system, progress of the program.

According to another embodiment, one or more computer-readable non-transitory storage media embody instructions that, when executed by a processor, cause the processor to perform operations. The operations include sharing, via a pub-sub bus, an unaddressed message between a plurality of agents. The unaddressed message includes a program counter pointing to a first instruction of a program written in a programming language. The operations also include determining, by each respective agent of the plurality of agents, whether the respective agent can perform the instruction and, in response to a first agent of the plurality of agents determining that the first agent can perform the instruction, consuming, by the first agent, the unaddressed message. The operations further include removing, by the first agent, the unaddressed message from the bus, performing, by the first agent, the instruction, adding, by the first agent, one to the program counter, and posting, by the first agent, a response to the pub-sub bus for further processing of the program.

According to yet another embodiment, a system includes a pub-sub bus that shares an unaddressed message between a plurality of agents. The unaddressed message includes a program counter pointing to a first instruction of a program written in a programming language. The system also includes a plurality of agents. The plurality of agents determines, by each respective agent of the plurality of agents, whether the respective agent can perform the instruction. A first agent of the plurality of agents consumes, in response to determining that the first agent can perform the instruction, the unaddressed message, removes the unaddressed message from the bus, performs the instruction, adds one to the program counter, and posts a response to the pub-sub bus for further processing of the program.

Technical advantages of certain embodiments of this disclosure may include one or more of the following. In one or more embodiments, a distributed agentic applications network is created such that operations may be executed by one or more application agents. As an agentic problem starts, data context may contain one or more operations to be executed, and a program counter may point to an initial instruction. This instruction may include one or various levels of specificity. The instructions may include one or more threshold ranges and/or requirements. Multiple messages and/or operations may be performed in sequence and/or in parallel. Replicated messages may be corrected, and repeated versions may be eliminated and/or deleted. Certain embodiments include a programming language, an execution mechanism, control functions in that programming language, and mechanisms to carry an agentic AI program across a set of distributed application agents. Certain embodiments allow developers and large language models (LLMs) to build and generate distributed agentic programs that may be run as distributed applications. Some embodiments build, host, and/or control distributed agentic applications, allow for parallelizing agentic functions, allow for integration of intermediate results, allow late binding of required agent functionality to actual application agents, and/or allow LLMs to generate those applications. In one or more embodiments, a system provides a toolbox for developers and LLMs to build and generate distributed agentic programs (e.g., applications) configured to run as distributed applications with late-binding functions. In certain embodiments, the system provides programmers with resources to distribute operations performed by multiple agents in a decentralized approach.

The complete decentralization of implementing applications allows a developer (or LLM) to focus solely on the functional aspects of applications. Since the execution is implicitly organized by the agents itself, and since there are no “compiled-in” links between the pub-sub bus and the agents, agents can be replaced simply by installing a new one on the bus and removing the old. Rather than focusing on the implementation of the agents, the developer can simply focus on what functions are available, what their “dialect” is (e.g., what natural language they use to communicate), and how to articulate the application logic requirements. If an AI model is used to generate the application, that AI model mainly needs to focus on the functional aspects of the application given its set of available agents.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

This disclosure describes systems and methods for decentralizing agentic applications. In one or more embodiments, agentic applications are applications where application agents perform one or more communication operations and/or data exchange operations. The application agents may include one or more natural language interfaces. The application agents may perform one or more operations unilaterally and/or coordinate operations as a group and/or team.

Contrary to certain agentic solutions that may be centralized and/or hosted in a single process, in a single container and are implemented as a sequence of functions that are called one after the other, the systems and/or methods described herein implement one or more decentralized agentic solutions that may be hosted to one or more sequential and/or parallel processes. One or more systems and methods described herein include a mechanism where true application distribution is realized specifically for agentic applications. The system may be configured to run several agentic applications in a set of distributed agents, where the agentic applications configured to be executed are embedded in the data exchanged by application agents. Each application agent may accept a message, execute one or more operations based on the contents of the message, increase a local program counter, and further the one or more operations to other application agents. Thus: an inherently robust, scalable, and distributed solution is thereby created for running agentic apps.

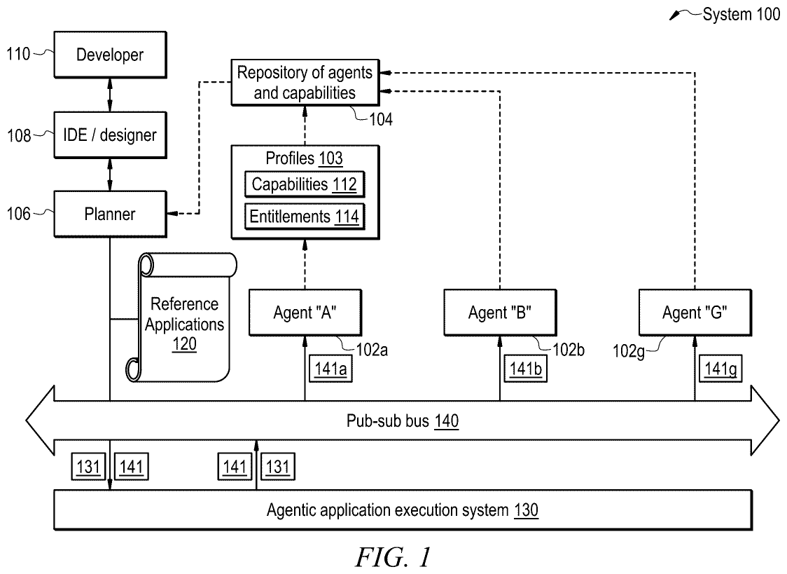

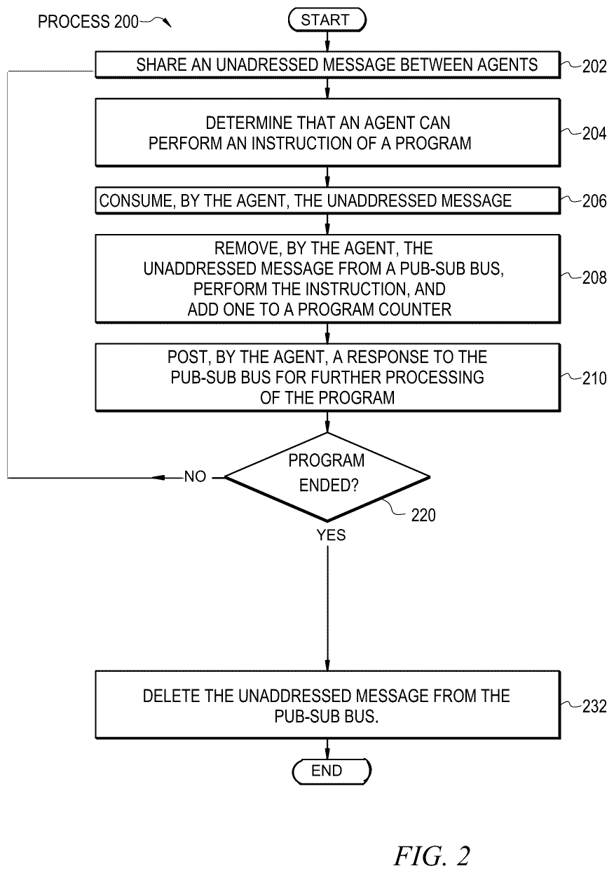

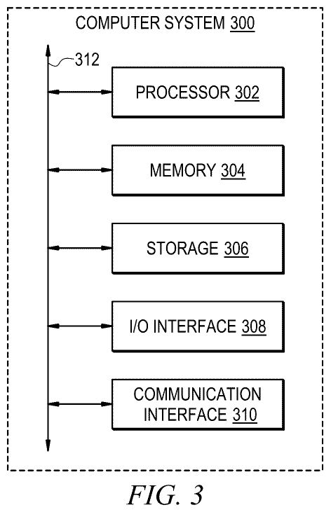

FIG. 1 illustrates an example system for decentralizing agentic applications, FIG. 2 illustrates an example method for decentralizing agentic applications, and FIG. 3 illustrates an example computer system that may be used by the system of FIG. 1 and/or the method of FIG. 2.

FIG. 1 illustrates a system 100 for decentralizing agentic applications, in accordance with certain embodiments. The system 100 includes multiple application agents 102 (e.g., represented by the application agent 102a, the application agent 102b, and the application agent 102g), a repository of agents and capabilities 104, a planner 106, an integrated development environment (IDE)/designer 108, a developer 110, one or more reference applications 120, an agentic application execution system 130, and a publish (pub)-subscribe (sub) bus. The system 100 may be configured to perform one or more publishing operations and/or subscribing operations.

The application agents 102 of the system 100 are software programs that act on behalf of a user or another application to perform specific tasks. In certain embodiments, system 100 maintains, develops, and/or provision generative AI application agents 102 as autonomous software entities configured to generate content (e.g., data, data programs, instructions, operational flows, and the like), make decisions, and interact with surrounding physical and/or virtual environments to complete specific tasks. The application agents 102 may interact with one or more physical and/or virtual environments via one or more peripherals and/or interfaces. In certain embodiments, the application agents 102 adapt and learn from new data and/or information, offering flexibility and handling complex tasks without and/or with less human intervention. In some embodiments, the application agents 102 include one or more reflective agents that analyze previous agentic actions and/or decisions, adapt based on feedback summarized from the analyses, and perform one or more updated operations to improve over time. The application agents 102 may be one or more tool agents that continuously monitor agentic performance against predefined target performance parameters. In some embodiments, the application agents 102 determine areas in which agentic operations may be deficient, determine one or more solutions to inhibit, solve, and/or eliminate any determined deficiencies, and/or update one or more configuration parameters in accordance with the one or more solutions. The application agents 102 may invoke one or more tools to perform one or more tasks. In one or more embodiments, the application agents 102 are model-based reflex agents configured to use one or more internal models of the environment to make decisions. The application agents 102 may evaluate a current state of system 100 and historic data associated with one or more previous states, compare one or more evaluation results against one or more internal models, and make one or more informed decisions based on one or more comparison results. The internal models may enable the application agents 102 to monitor and/or handle more complex scenarios, such as scenarios in which tasks depends on an understanding of one or more operational trends and/or system performances over time.

The repository of agents and capabilities 104 may be one or more information and/or data repositories in which configuration parameters and/or operational capabilities are stored in accordance with one or more indexed commands. The repository of agents and capabilities 104 may include one or more profiles 103 associated with the application agents 102. Each profile may be associated with a specific application agent 102. Each profile 103 may include information referencing capabilities 112 and/or entitlements 114 associated with the corresponding application agent 102. The profiles 103 may include similar information among a portion of the application agents 102. The profiles 103 may include unique information for each of the application agents 102. The capabilities 112 may reference specific knowledge areas and/or operational resources (e.g., power, memory, and/or processing) associated with a specific application agent 102. The entitlements 114 may reference specific access to programs, applications, and/or encryption granted to the one or more application agents 102.

In certain embodiments, the planner 106 plans and/or composes one or more operations and/or tasks. In some embodiments, the IDE/designer 108 represent one or more designing commands that modify and/or optimize operation development and/or creation. In certain embodiments, the developer 110 is a person/entity that performs one or more development operations and/or creates and/or maintains new operations and/or tasks. In some embodiments, the reference applications 120 represent services that perform one or more operations. The reference applications 120 may be a platform that performs one or more specific tasks in accordance with one or more instructions. The agentic application execution system 130 represents one or more systems for executing one or more of the reference applications 120 in accordance with guidance provided by the developer 110 and/or application agents 102. The pub-sub bus 140 may be an asynchronous and/or scalable messaging service bus that decouples services producing messages 141 (e.g., messages 141a, messages 141b, and messages 141g among others) from services processing the messages 141. The pub-sub bus 140 may receive, provide, and/or update operations and/or tasks to be performed by one or more of the application agents 102.

In the example of FIG. 1, the system 100 includes a mechanism to encode and run one or more distributed agentic artificial intelligence (AI) applications inside one or more data context for a set of application agents 102. The application agents 102 may be previously known and/or newly integrated in a pool of agents. In certain embodiments, the system 100 combines agentic data and/or context and programs into the repository of agents and capabilities 104. The system 100 may include a mechanism to carry several agentic data, context, and/or program messages 141 by way of the pub-sub bus 140. In this regard, the system 100 allows a decentralized approach for application development and agentic implementation, where one or more of the application agents 102 may automatically and/or dynamically collectively generate solutions, solve problems, and/or perform tasks and/or operations.

In the illustrated embodiment of FIG. 1, the application agents 102 solve complex tasks, perform complex operations, and/or reach target performance parameters (e.g., parameter value goals and/or within a threshold range) autonomously and/or semi-autonomously. In some embodiments, the application agents 102 are wrapped around one or more ML cores (with and/or without callouts to application programming interface (API) services), extended with regular code, work together to generate solutions to a stated problem, and/or collectively and/or by consensus generate an acceptable (e.g., within a predefined and/or dynamically generated threshold) outcome to one or more operations and/or tasks.

The application agents 102 may be pre-canned, self-trained, and/or generated while using existing models, by way of tooling, and/or specifically fine-tuned for use-cases. In certain embodiments, the application agents 102 are scalable to increase or reduce specific numbers of application agents 102 available in a decentralized (e.g., not centralized and/or distributed) network. The application agents 102 may be scalable to increase and or reduce specific numbers of resources (e.g., processing resources, memory resources, and/or power resources) available and/or programmed in application agents 102 available in a decentralized (e.g., not centralized and/or distributed) network. In one or more embodiments, the application agents 102 automate software development, automate application operations, automate cloud security processes, implement and/or maintain cloud application operations, manage financial operations, handle customer management campaigns, and/or organize travel and healthcare among others.

In one or more embodiments, the application agents 102 perform one or more communication frameworks and/or communication protocols in a decentralized approach. The system 100 may not include a single interpreter, hosted on a single process, and/or embedded in a container to operate all the application agents 102. The application agents 102 may dynamically post assignments, tasks, and/or operations on the pub-sub bus 140. In certain embodiments, the application agents 102 dynamically retrieve assignments, tasks, and/or operations from the pub-sub bus 140.

The application agents 102 may be configured with a natural language interface and/or another interface with the pub-sub bus 140 to obtain programs and/or put the programs back onto the pub-sub bus 140 for additional processing and/or analyses. The application agents 102 may possess one or more capabilities defined in accordance with one or more configuration parameters. In the example of FIG. 1, the capabilities of the application agents 102 may be stored, referenced, and/or described in a database or model such as the repository of agents and capabilities 104. The planner 106 may plan and/or compose tasks and/or operations and/or include the application agents 102 into a composed application, a set of tasks, and/or one or more operations. The application agents 102 may be individually and/or collectively created in accordance with one or more generation, manufacturing, and/or creation of artificial intelligence agents.

The reference applications 120 may be one or more combinations of agentic data (e.g., context information), one or more services associated with the application agents 102, and/or one or more program counters. The data in the context may be a set of data fields that are used by the reference applications 120 and may be carried and/or shared between one or more application agents 102. In certain embodiments, the reference applications 120 include one or more information elements configured to abstractly, referentially, and/or explicitly describe one or more operations, functions, and/or processes to complete one or more operations and/or processes. The reference applications 120 may include one or more information elements configured to abstractly, referentially, and/or explicitly describe a time duration and/or one or more conditions for performing one or more operations and/or processes. The program counter may reference one or more instructions in a program.

In one or more embodiments, the repository of agents and capabilities 104 may be a database and/or model that captures, indexes, and/or stores capabilities and/or configuration parameters of application agents 102 that are available for crafting agentic applications and/or operational flows. In certain embodiments, the developer 110, the IDE/designer 108, and the planner 106 are configured to interact with the repository of agents and capabilities 104 to craft agentic applications and/or operational flows.

The pub-sub bus 140 may be a mechanism to share messages 141 (e.g., data messages, logic messages, and/or a combination of data and logic messages) between application agents 102. A message 141 may be posted to the pub-sub bus 140 by one of the and consumed by another agent. In one or more embodiments, the agentic application execution system 130 (e.g., which can be implemented as its own application agent 102) is configured to track progress of messages and/or programs across the pub-sub bus 140. The agentic application execution system 130 may monitor and/or control message delivery and/or completion. In certain embodiments, the agentic application execution system 130 ensures that messages and/or programs are picked up and/or processed by application agents 102 within a predefined time duration. In some embodiments, the agentic application execution system 130 flags messages and/or programs that are not picked up and/or processed by the application agents 102 within the predefined time duration. The system 100 may waitlist and/or terminate messages and/or programs that are flagged. The agentic application execution system 130 may be extended with observability functions to track progress of tasks and/or operations performed by the application agents 102.

In one or more embodiments, an operational flow performed by the system 100 may start at the application agents 102, where the application agents 102 may be maintained, created, and/or generated in accordance with one or more frameworks and/or protocols. The application agents 102 may share one or more corresponding capabilities to the repository of agent and capabilities 104. In some embodiments, the planner 106, the IDE/designer 108, and/or the developer 110 craft, develop, and/or create one or more applications 120 and/or services based on information and/or data stored in the repository of agents and capabilities 104. In some embodiments, to fill and/or train program and/or machine learning models, the capabilities of the application agents 102 are described in natural language and accompanied by a set of examples and/or application topologies that may work in cooperation for one or more specific application agents 102.

The repository of agent and capabilities 104 may be configured based on information in one or more databases and/or model-of-models. The operational flow may continue at the planner 106, the IDE/designer 108, and/or the developer 110, where the IDE/designer 108 and the developer 110 work with the databases and/or model-of-models to craft and/or infer an agentic application and/or agentic operational flows. The databases and/or the model-of-models provide one or more back-end of the system 100 to provide resources to the developer 110 to modify and/or develop new agentic applications, services, and/or operational flows with the repository of agent and capabilities 104 providing a set of application agents 102 that are available for the developer 110, while the model-of-models may support inference of entire sections of programs, services, and/or operational flows.

In one or more embodiments, the reference applications 120 are one or more services generated by the planner 106, the IDE/designer 108, and/or the developer 110 based on the contents of the repository of agent and capabilities 104. The reference applications 120 may include one or more state configurations and/or resources used for execution of one or more operational flows and/or programs. The agentic application execution system 130 may obtain the reference applications 120 and publish one or more operational flows and/or programs on the pub-sub bus 140 as one or more messages 141 including triggering commands and/or instructions for one or more application agents 102. At the pub-sub bus 140, these messages 141 may be carried between the agents, under control of the agentic application execution system 130. The agentic application execution system 130 may provide message persistence and application progressing by encapsulating data and program triggers in the messages 141. In this regard, the agentic application execution system 130 may build truly distributed systems and enabling distributed agentic operations.

As a non-limiting example, the operational flow may be implemented assuming a use case including an example prompt stating: “What is needed is an application that takes a set of blog articles from an API service, rewrites those blogs into a press-release, and posts the results into a marketing API. Make sure that the press-release is reviewed until a certain quality is reached.” Herein, the system 100 may assume that there are two APIs, one to obtain a blog post from a repository of blog posts and one to post the blog posts when the blog posts are abstractly described following a form, a definite operation process, and/or a specific format. Initially, instructions for the operational flow may be generated as follow:

# List the Internet API services that need to be used with all the parameters
needed for the service.
service(SRC “API endpoint for a document retriever for documents from blogs
sites”, URL <url>, Auth <auth>, APIspec <spec>)
service(DST, “API endpoint for posting documents to an API service”, URL
<url>, Auth <auth>, APIspec <spec>)

In one or more embodiments, the system 100 may determine “SRC” (source endpoint) and “DST” (destination endpoint) as variables for the API services provides by the endpoints. The endpoints may be services that are available on the Internet or in an extranet. At this stage, the system may define a set of application agents 102 for the agentic service as follows:

# the following list contain a series of examples how the various tools can be
used with the appropriate prompts and prior examples.
# these are used for training a model on the tool use
tool(DR, “document retriever for API services”, svc SRC, prompt “...”,
resources = ‘...’)
tool(CR, “combine and rewrite document”, prompt “...”)
tool(RQ, “review docs and provide qualitative response”, prompt “...”)
tool(PD, “publish document on a destination”, svc DST, prompt “...”)
tool(TQ, “test for quality”, prompt “...”)
tool(DCR, “combines documents from multiple sources, rewrites, critiques and
publishes these”, svc SRC, srv DST)
# control functions
tool(FL, “for loop with a maximum value”, prompt “add one to received data,
max value <max>; if max has been reached say ‘max value has been reached’
and say its value”, PC=<...>)
tool(LB)
tool(GT, “Goto a label”, PC=<...>)

As shown above, the instructions may describe a set of application agents 102 that are available for an agentic application composition. In the aforementioned example, the instructions show a tool “DR” (a document retriever tool) that implements a document retriever from an API service and uses an earlier defined “SRC” API service. The instructions may include providing a prompt as an instruction to an agent builder for building an application agent 102a that wraps around the “SRC.” Similarly, the agent “PD” (publish document agent) may perform one or more opposite with a “DST” API service. One or more agents “CR” (combine and rewrite document agent) and “RQ” (review documents and provide a qualitative response agent) may take a message and/or program from the pub-sub bus 140 and when activated first combine a set of blog posts into a comprehensive message 141, while an agent “RQ” (review documents and provide a qualitative response agent) may review one or more intermediate results as received from the agent “CR”. In some embodiments, as the agent RQ may be finished, the agent RQ may make available a result for further processing. An agent “TQ” (test for quality agent) may take the result from the message and/or program and test and/or evaluate whether the result is appropriate in accordance with one or more quality guidelines. The “DCR” is an application agent 102b that may operate as a “main” function of the program. The optional resources clause describes one or more instructions to reassign resources for a given agent, should reassignment of resources be dynamically generated.

In one or more embodiments, an agent “FL” (for loop with a maximum value agent) may implement a “for-loop” configured to take a message 141 and implement the “for-loop” per the example and posts a message 141 with the result. Separately, there may be agents that implement program labels (e.g., an agent and/or tool “LB”) and agents that configure the program counter of the application (e.g., go-to: “GT”, if-then-else-fi: “IF”, exception: “EXC”).

In one or more embodiments, the messages 141 may be replicated over multiple application agents 102 if multiple viewpoints are requested and when multiple such viewpoints are aggregated into one or more solutions. Herein, the system enables probabilistic distributed operations between a set of agents (e.g., “replicate a message to N agents capable of testing the quality of a rewritten blog and pick the lowest verdict response”). These operations may be, as expected, specific agents that may perform, executing, and/or implementation of the tasks, programs, and/or operations.

# An application template describes the agentic application that can be inferred from the model.

```
app-template(DCR):
  # Definitions
  data(FB, “feedback parameters that are initially none”)
  data(D, “set of documents”)
  data(Q, “A qualitative indication if results are good or bad”)
  data(CNT, “A counter whose value is initially zero”)
  # Program
  tool DR, output D
  tool FL, input CNT, output CNT, PC=A|E
  A: tool LB
  tool CR, input D, input FB, output D
  tool RQ, input D, output Q, output FB
  tool TQ, input Q, PC=A|B
  tool PD, input D, input B
  tool LB, input E
E: exit
```

In one or more embodiments, the system 100 builds a first message 141 including one or more configuration parameters of the application (e.g., “FB”, “D”, “Q”, “CNT”) captured in natural language. The configuration parameters may be considered as the context of one or more tasks and/or operational flow. The configuration parameters may be provided to the application agents 102 of the one or more tasks and/or the operational flow. The system 100 may consider the configuration parameters as global parameters of the one or more tasks and/or the operational flow. The one or more tasks and/or the operational flow may be copied entirely into the message 141 and the message 141 may be extended with a program counter (“PC”) that points at an initial instruction of the one or more tasks and/or the operational flow. In the aforementioned example, the initial instruction is: “document retriever from API services.” Once this data structure is formulated in accordance with the planner 106, the one or more tasks and/or the operational flow may be ready for execution.

To start a program, a task, and/or an operational flow, the message 141 is submitted to an execution environment via the agentic application execution system 130. The agentic application execution system 130 takes the program, queues the program, and posts the message and/or program the pub-sub bus 140. At the pub-sub bus 140, the message and/or program may be available to one or more available application agents 102 to pick up the message and/or program. In accordance with the aforementioned example, the application agents 102 may provide a function “document retriever from API services” with an associated parameters, read the message 141 from the pub-sub bus 140, operate on the message and/or the program, rewrite a data portion of the message and/or the program, update the program counter per the program (e.g., the program counter now says “for loop with a maximum value . . . ,” and post the message 141 back to the pub-sub bus 140. Herein, a next agent may pick up the message 141. In one or more embodiments, when the program reaches the keyword “exit,” the agent program may exit altogether.

In one or more embodiments, reference labels for the agents are precise, detailed, and/or a combination of the two. By making such reference labels precise and detailed, a specific agent may be selected. At a same time, by way of the planner 106, a class and/or a group of agents may be selected into the program. The binding between a specific agent and the application may happen at a late stage (e.g., during execution) and may even change during execution. In this regard, while the binding between the reference labels of the agents and the instance of the agents is precise, the binding may be relaxed over time.

In one or more embodiments, the agentic application execution system 130 may track progress of messages 141 and/or operations as the messages 141 are picked up and/or returned by agents.

Although FIG. 1 illustrates a particular number of components of the system 100, this disclosure contemplates any suitable number of components. Although FIG. 1 illustrates a particular arrangement of the components of the system 100, this disclosure contemplates any suitable arrangement of the components. Furthermore, although FIG. 1 describes and illustrates particular components, devices, or systems performing particular actions, this disclosure contemplates any suitable combination of any suitable components, devices, or systems performing any suitable actions.

FIG. 2 illustrates a process 200 of building a decentralized network of application agents, in accordance with certain embodiments. The process 200 may be applicable to communications accessing data between a server and/or one or more user devices. In certain embodiments, the process 200 may be used by the system 100 of FIG. 1. In some embodiments, while operations 202-232 are shown in a specific order, alternative arrangements may be performed such as one or more operations being performed in different sequences, in parallel, and/or omitting one or more of the operations 202-232. The operations 202-238 may cause one or more data exchanges performed between application agents, one or more servers, and/or one or more systems among other components and/or electronic devices.

The process 200 starts at operation 202, where the system (e.g., system 100 of FIG. 1) shares, via a pub-sub bus (e.g., pub-sub bus 140 of FIG. 1), an unaddressed message between a plurality of agents (e.g., application agents 102 of FIG. 1).

The plurality of agents includes one or more agents that implement control functions in a programming language. The application agents may be configured with a natural language interface and/or another interface with the pub-sub bus to obtain programs and/or put the programs back onto the pub-sub bus for additional processing and/or analyses. The unaddressed message includes a program counter pointing to a first instruction of a program written in a programming language. The program includes multiple instructions.

At operation 204, the system then determines, by each respective agent of the plurality of agents, whether the respective agent can perform the instruction. For example, the first instruction may include one or more threshold ranges and/or requirements, and the respective agent determines whether the agent can perform the instruction in accordance with the threshold ranges and/or requirements.

At operation 206, in response to the first agent of the plurality of agents determining that the first agent can perform the instruction, the first agent consumes the unaddressed message. At operation 208, the agent removes the unaddressed message from the pub-sub bus, performs the instruction, and adds one to the program counter. For example, the application agent may read the unaddressed message from the pub-sub bus, operate on the message and/or the program, rewrite a data portion of the message and/or the program, and update the program counter per the program

At step 210, the first agent posts a response to the pub-sub bus for further processing of the program. At step 220, an agent (e.g., a program-end-agent) determines whether the program ended. If the program has not ended, process 200 repeats steps 202-210 with a different application agent. If, at step 220, an agent determines that the program ended, the process 200 moves to operation 232, where the agent deletes the unaddressed message from the pub-sub bus. Process 200 ends at operation 232.

In certain embodiments, the unaddressed message may encounter an error. If the unaddressed message encounters an error (e.g., the program gets stuck, fails, or indicates an error), a special execution agent hosted on the pub-sub bus captures the unaddressed message to make sure the program finishes.

In some embodiments, several agents need to work on a message in parallel. In this instance, a first agent of the plurality of agents can replicate the unaddressed message to create a replicated unaddressed message. The agent posts the replicated unaddressed message to the pub-sub bus so that other agents can consume the replicated unaddressed message and perform the instruction of the program in parallel with the first agent.

Although this disclosure describes and illustrates particular operations in the process 200 of FIG. 2 as occurring in a particular order, this disclosure contemplates any suitable steps of the process 200 of FIG. 2 occurring in any suitable order. Although this disclosure describes and illustrates an example method of building a decentralized network of application agents including the particular steps of the method of FIG. 2, this disclosure contemplates any suitable method of building a decentralized network of application agents including any suitable steps, which may include all, some, or none of the steps of the method of FIG. 2, where appropriate.

Furthermore, although FIG. 2 describes and illustrates particular components, devices, or systems performing particular actions, this disclosure contemplates any suitable combination of any suitable components, devices, or systems performing any suitable actions. For example, process 200 may include replacing an agent by removing the agent from the pub-sub bus and installing a new agent on the pub-sub bus. As another example, process 200 may include tracking, by an execution system, progress of the program.

FIG. 3 illustrates an example computer system 300. In particular embodiments, one or more computer system 300 perform one or more steps of one or more methods described or illustrated herein. In particular embodiments, the one or more computer system 300 provide functionality described or illustrated herein. In particular embodiments, software running the on one or more computer system 300 performs one or more steps of one or more methods described or illustrated herein or provides functionality described or illustrated herein. Particular embodiments include one or more portions of the one or more computer system 300. Herein, reference to a computer system may encompass a computing device, and vice versa, where appropriate. Moreover, reference to a computer system may encompass one or more computer systems, where appropriate.

This disclosure contemplates any suitable number of computer system 300. This disclosure contemplates the computer system 300 taking any suitable physical form. As example and not by way of limitation, the computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 300 may include the one or more computer system 300; be unitary or distributed; span multiple locations; span multiple machines; span multiple data centers; or reside in a cloud, which may include one or more cloud components in one or more networks. Where appropriate, the one or more computer system 300 may perform without substantial spatial or temporal limitation one or more steps of one or more methods described or illustrated herein. As an example, and not by way of limitation, the one or more computer system 300 may perform in real time or in batch mode one or more steps of one or more methods described or illustrated herein. The one or more computer system 300 may perform at different times or at different locations one or more steps of one or more methods described or illustrated herein, where appropriate.

In particular embodiments, the computer system 300 includes a processor 302, a memory 304, a storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 302 includes hardware for executing instructions, such as those making up a computer program. As an example, and not by way of limitation, to execute instructions, the processor 302 may retrieve (or fetch) the instructions from an internal register, an internal cache, the memory 304, or the storage 306; decode and execute them; and then write one or more results to an internal register, an internal cache, the memory 304, or the storage 306. In particular embodiments, the processor 302 may include one or more internal caches for data, instructions, or addresses. This disclosure contemplates the processor 302 including any suitable number of any suitable internal caches, where appropriate. As an example, and not by way of limitation, the processor 302 may include one or more instruction caches, one or more data caches, and one or more translation lookaside buffers (TLBs). Instructions in the instruction caches may be copies of instructions in the memory 304 or the storage 306, and the instruction caches may speed up retrieval of those instructions by the processor 302. Data in the data caches may be copies of data in the memory 304 or the storage 306 for instructions executing at the processor 302 to operate on; the results of previous instructions executed at the processor 302 for access by subsequent instructions executing at the processor 302 or for writing to the memory 304 or the storage 306; or other suitable data. The data caches may speed up read or write operations by the processor 302. The TLBs may speed up virtual-address translation for processor 302. In particular embodiments, processor 302 may include one or more internal registers for data, instructions, or addresses. This disclosure contemplates the processor 302 including any suitable number of any suitable internal registers, where appropriate. Where appropriate, the processor 302 may include one or more arithmetic logic units (ALUs); be a multi-core processor; or include one or more processors 302. Although this disclosure describes and illustrates a particular processor, this disclosure contemplates any suitable processor.

In particular embodiments, the memory 304 includes main memory for storing instructions for the processor 302 to execute or data for the processor 302 to operate on. As an example, and not by way of limitation, the computer system 300 may load instructions from storage 306 or another source (such as, for example, another computer system 300) to the memory 304. The processor 302 may then load the instructions from the memory 304 to an internal register or internal cache. To execute the instructions, the processor 302 may retrieve the instructions from the internal register or internal cache and decode them. During or after execution of the instructions, the processor 302 may write one or more results (which may be intermediate or final results) to the internal register or internal cache. The processor 302 may then write one or more of those results to memory 304. In particular embodiments, the processor 302 executes only instructions in one or more internal registers or internal caches or in the memory 304 (as opposed to the storage 306 or elsewhere) and operates only on data in one or more internal registers or internal caches or in the memory 304 (as opposed to the storage 306 or elsewhere). One or more memory buses (which may each include an address bus and a data bus) may couple the processor 302 to the memory 304. The bus 312 may include one or more memory buses, as described below. In particular embodiments, one or more memory management units (MMUs) reside between the processor 302 and the memory 304 and facilitate accesses to the memory 304 requested by the processor 302. In particular embodiments, the memory 304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. The memory 304 may include one or more memories 304, where appropriate. Although this disclosure describes and illustrates particular memory, this disclosure contemplates any suitable memory.

In particular embodiments, the storage 306 includes mass storage for data or instructions. As an example, and not by way of limitation, the storage 306 may include a hard disk drive (HDD), a floppy disk drive, flash memory, an optical disc, a magneto-optical disc, magnetic tape, or a Universal Serial Bus (USB) drive or a combination of two or more of these. The storage 306 may include removable or non-removable (or fixed) media, where appropriate. The storage 306 may be internal or external to the computer system 300, where appropriate. In particular embodiments, the storage 306 is non-volatile, solid-state memory. In particular embodiments, the storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates a mass storage 306 taking any suitable physical form. The storage 306 may include one or more storage control units facilitating communication between the processor 302 and the storage 306, where appropriate. Where appropriate, the storage 306 may include one or more storages 306. Although this disclosure describes and illustrates particular storage, this disclosure contemplates any suitable storage.

In particular embodiments, the I/O interface 308 includes hardware, software, or both, providing one or more interfaces for communication between the computer system 300 and one or more I/O devices. The computer system 300 may include one or more of these I/O devices, where appropriate. One or more of these I/O devices may enable communication between a person and the computer system 300. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, the I/O interface 308 may include one or more device or software drivers enabling processor 402 to drive one or more of these I/O devices. The I/O interface 308 may include one or more I/O interfaces 308, where appropriate. Although this disclosure describes and illustrates a particular I/O interface, this disclosure contemplates any suitable I/O interface.

In particular embodiments, the communication interface 310 includes hardware, software, or both providing one or more interfaces for communication (such as, for example, packet-based communication) between the computer system 300 and one or more other computer system 300 or one or more networks. As an example, and not by way of limitation, the communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example, and not by way of limitation, the computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. The computer system 300 may include any suitable communication interface 310 for any of these networks, where appropriate. The communication interface 310 may include one or more communication interfaces 310, where appropriate. Although this disclosure describes and illustrates a particular communication interface, this disclosure contemplates any suitable communication interface.

In particular embodiments, the bus 312 includes hardware, software, or both coupling components of the computer system 300 to each other. As an example and not by way of limitation, the bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. The bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein.

Modifications, additions, or omissions may be made to the elements shown in the figures above. The components of a device may be integrated or separated. Moreover, the functionality of a device may be performed by more, fewer, or other components. The components within a device may be communicatively coupled in any suitable manner. Functionality described herein may be performed by one device or distributed across multiple devices. In general, systems and/or components described in this disclosure as performing certain functionality may include non-transitory computer readable memory storing instructions and processing circuitry operable to execute the instructions to cause the system/component to perform the described functionality.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

Any appropriate steps, methods, features, functions, or benefits disclosed herein may be performed through one or more functional units or modules of one or more virtual apparatuses. Each virtual apparatus may include a number of these functional units. These functional units may be implemented via processing circuitry configured to execute program code stored in memory. The term unit may have conventional meaning in the field of electronics, electrical devices and/or electronic devices and may include, for example, electrical and/or electronic circuitry, devices, modules, processors, receivers, transmitters, memories, logic solid state and/or discrete devices, computer programs or instructions for carrying out respective tasks, procedures, computations, outputs, and/or displaying functions, and so on, as such as those that are described herein.

What is claimed is:

1. A method, comprising:
sharing, via a publication-subscription (pub-sub) bus, an unaddressed message between a plurality of agents, wherein the unaddressed message comprises a program counter pointing to a first instruction of a program written in a programming language;
determining, by each respective agent of the plurality of agents, whether the respective agent can perform the instruction;
in response to a first agent of the plurality of agents determining that the first agent can perform the instruction, consuming, by the first agent, the unaddressed message;
removing, by the first agent, the unaddressed message from the pub-sub bus;
performing, by the first agent, the instruction;
adding, by the first agent, one to the program counter; and
posting, by the first agent, a response to the pub-sub bus for further processing of the program.

2. The method of claim 1, further comprising:
determining, by a second agent of the plurality of agents, that the program ended; and
deleting, by the second agent and in response to determining that the program ended, the unaddressed message from the pub-sub bus.

3. The method of claim 1, further comprising capturing, by a second agent of the plurality of agents, the unaddressed message in response to the unaddressed message encountering an error.

4. The method of claim 1, further comprising:
replicating, by a second agent of the plurality of agents, the unaddressed message to create a replicated unaddressed message;
posting, by the second agent, the replicated unaddressed message to the pub-sub bus;
consuming, by a third agent of the plurality of agents, the replicated unaddressed message; and
performing, by the second agent, an instruction of the program in parallel with the first agent.

5. The method of claim 1, further comprising replacing the first agent by removing the first agent from the pub-sub bus and installing a new agent on the pub-sub bus.

6. The method of claim 1, wherein the plurality of agents comprises one or more agents that implement control functions in the programming language.

7. The method of claim 1, further comprising tracking, by an execution system, progress of the program.

8. A non-transitory computer-readable medium storing instructions that, when executed by a processor, cause the processor to perform operations comprising:
sharing, via a publication-subscription (pub-sub) bus, an unaddressed message between a plurality of agents, wherein the unaddressed message comprises a program counter pointing to a first instruction of a program written in a programming language;
determining, by each respective agent of the plurality of agents, whether the respective agent can perform the instruction;
in response to a first agent of the plurality of agents determining that the first agent can perform the instruction, consuming, by the first agent, the unaddressed message;
removing, by the first agent, the unaddressed message from the pub-sub bus;
performing, by the first agent, the instruction;
adding, by the first agent, one to the program counter; and
posting, by the first agent, a response to the pub-sub bus for further processing of the program.

9. The non-transitory computer-readable medium of claim 8, the operations further comprising:
determining, by a second agent of the plurality of agents, that the program ended; and
deleting, by the second agent and in response to determining that the program ended, the unaddressed message from the pub-sub bus.

10. The non-transitory computer-readable medium of claim 8, the operations further comprising capturing, by a second agent of the plurality of agents, the unaddressed message in response to the unaddressed message encountering an error.

11. The non-transitory computer-readable medium of claim 8, the operations further comprising:
replicating, by a second agent of the plurality of agents, the unaddressed message to create a replicated unaddressed message;
posting, by the second agent, the replicated unaddressed message to the pub-sub bus;
consuming, by a third agent of the plurality of agents, the replicated unaddressed message; and
performing, by the second agent, an instruction of the program in parallel with the first agent.

12. The non-transitory computer-readable medium of claim 8, the operations further comprising replacing the first agent by removing the first agent from the pub-sub bus and installing a new agent on the pub-sub bus.

13. The non-transitory computer-readable medium of claim 8, wherein the plurality of agents comprises one or more agents that implement control functions in the programming language.

14. The non-transitory computer-readable medium of claim 8, the operations further comprising tracking, by an execution system, progress of the program.

15. A system, comprising:
a publication-subscription (pub-sub) bus that shares an unaddressed message between a plurality of agents, wherein the unaddressed message comprises a program counter pointing to a first instruction of a program written in a programming language;
a plurality of agents, that determines, by each respective agent of the plurality of agents, whether the respective agent can perform the instruction; and
a first agent of the plurality of agents:
consumes, in response to determining that the first agent can perform the instruction, the unaddressed message;
removes the unaddressed message from the pub-sub bus;
performs the instruction;
add one to the program counter; and
posts a response to the pub-sub bus for further processing of the program.

16. The system of claim 15, wherein a second agent of the plurality of agents:
determines that the program ended; and
deletes, in response to determining that the program ended, the unaddressed message from the pub-sub bus.

17. The system of claim 15, wherein a second agent of the plurality of agents captures the unaddressed message in response to the unaddressed message encountering an error.

18. The system of claim 15, wherein:
a second agent of the plurality of agents replicates the unaddressed message to create a replicated unaddressed message and posts the replicated unaddressed message to the pub-sub bus; and
a third agent of the plurality of agents consumes the replicated unaddressed message and performs an instruction of the program in parallel with the first agent.

19. The system of claim 15, wherein the first agent is replaced by removing the first agent from the pub-sub bus and installing a new agent on the pub-sub bus.

20. The system of claim 15, wherein the plurality of agents comprises one or more agents that implement control functions in the programming language.
